(19) United States
(12) Patent Application Publication
(10) Pub. No.: US 2025/0172685 A1
(43) Pub. Date: May 29, 2025

(54) Quality Indicator for High Accuracy Distance Measurements

(71) Applicant: Silicon Laboratories Inc., Austin, TX (US)

(72) Inventors: Sauli Lehtimaki, Nummela (FI); Janika Tang, Espoo (FI); Mika Lansirinne, Espoo (FI)

(21) Appl. No.: 18/521,379

(22) Filed: Nov. 28, 2023

(51) Int. Cl. G01S 13/76; G01S 13/87

(52) U.S. Cl. CPC G01S 13/76; G01S 13/878

(57) ABSTRACT

A system and method for determining the quality of a distance measurement performed between two wireless network devices is disclosed. The present performs round trip system time calculations on a plurality of Bluetooth channels and compares the results from these various calculations. Based on these results, the system provides an indication of the perceived quality of the computed distance. In some embodiments, this quality indicator is expressed as a distance. In other embodiments, this quality indicator is expressed as a likelihood or confidence level.

### FIELD

This disclosure describes systems and methods for calculating the distance between two wireless network devices, and specifically, creating a quality indicator associated with the calculated distance.

### BACKGROUND

The Bluetooth protocol has designed several techniques to implement high accuracy distance measurement (HADM). These include a phase based ranging approach and a round trip time approach. Typically, there are two devices associated with these approaches; an initiator device that initiates the distance measurement and a reflector device, which responds to the initiator device. The distance being measured is the distance between these two devices.

In the phase based approach, the initiator device determines the incoming phase for signals transmitted at two different frequencies. The phase measured (θᵢₙᵢₜ) at the initiator device may be approximately the difference in phase between the two devices (i.e. Δθᵢᵣ), added to the product 2π*f*(tp), where f is the frequency of the transmitted signal and tp is the trip delay. If this phase is measured at two different frequencies, and the difference is taken, the result is (θᵢₙᵢₜ₁)−(θᵢₙᵢₜ₂)=2π*f1*(tp)−2π*f2*(tp), or 2*π*(f1−f2)*(tp). Based on this equation, the trip delay may be calculated and then converted to a distance.

In the round trip time (RTT) approach, each device uses timestamps. Specifically, when a packet is transmitted, the transmitting device records a transmit timestamp. When that packet arrives, a receive timestamp is used by the receiving device. FIG. 2 shows a Bluetooth network 100 including a initiator device 10 and a reflector device 110. The sequence of operations is illustrated in FIG. 3. First, the initiator device 10 transmits a packet to the reflector device 110. As that packet is transmitted, the initiator device 10 creates a transmit timestamp, t₁. When that packet is received by the reflector device 110, the reflector device 110 creates a receive timestamp, t₂. Note that both devices may calibrate their transmit and receive circuits such that each is able to accurately determine when the packet first exited the antenna of the initiator device 10 and first entered the read circuit of the reflector device 110. First, note that the time reference of each device may differ. For illustration purposes, the offset between these two time references may be defined as to. Further, at a later time, the reflector device 110 transmits a second packet to the initiator device 10. As that packet is transmitted, the reflector device 110 creates a transmit timestamp, t₃. When that packet is received by the initiator device 10, the initiator device 10 creates a receive timestamp, t₄. Thus, the time delay for the first packet may be given by (t₂+t₀)−t₁. Similarly, the time delay for the second packet may be given by t₄−(t₃+t₀). Summing these time delays results in the cancellation of the offset, and yields (t₂−t₁)+(t₄−t₃).

This results in the round trip delay, which may be converted to distance by multiplying it by the speed of light and dividing by two. This process may be referred to as the RTT procedure.

However, testing has shown that this approach may produce different values when performed using different Bluetooth channels, especially in the presence of a multipath environment.

Therefore, it would be advantageous if there was a system and method of calculating a distance between two devices and providing an indication of the quality of the distance measurement. This may be beneficial in various situations.

### SUMMARY

A system and method for determining the distance and the quality of the distance measurement performed between two wireless network devices is disclosed. The present system performs round trip time calculations on a plurality of Bluetooth channels and compares the results from these various calculations. Based on these results, the system provides a computed distance as well as an indication of the perceived quality of the computed distance. In some embodiments, this quality indicator is expressed as a distance. In other embodiments, this quality indicator is expressed as a likelihood or confidence level.

According to one embodiment, a method of calculating a distance between two wireless devices and a quality indicator associated with the distance is disclosed. The method comprises performing a plurality of round trip time (RTT) procedures, each using one of a plurality of data channels, to generate a plurality of distance measurements; calculating the distance based on the plurality of distance measurements; and calculating the quality indicator based on the distance and the plurality of distance measurements. In some embodiments, the distance is calculated as an average of the plurality of distance measurements. In some embodiments, the distance is calculated as a median of the the plurality of distance measurements. In some embodiments, quality indicator is expressed as a distance deviation. In certain embodiments, the quality indicator is calculated using a standard deviation of the plurality of distance measurements. In certain embodiments, the quality indicator is calculated using a difference between a largest of the plurality of distance measurements and a smallest of the plurality of distance measurements. In certain embodiments, the quality indicator is calculated using a largest difference between one of the plurality of distance measurements and the distance. In some embodiments, the quality indicator is expressed as a value between 0 and 1 and is defined as 1 minus a product of a scaling factor multiplied by a distance deviation. In certain embodiments, the distance deviation is defined as a standard deviation of the plurality of distance measurements. In certain embodiments, the distance deviation is defined as a difference between a largest of the plurality of distance measurements and a smallest of the plurality of distance measurements. In certain embodiments, the distance deviation is defined as a largest difference between one of the plurality of distance measurements and the distance.

According to another embodiment, a method of determining a more accurate distance between two wireless devices is disclosed. The method comprises performing the method described above a plurality of times to obtain a plurality of distances and associated quality creating indicators; a weight factor corresponding to each of the plurality of distances based on the associated quality indicator; and calculating the more accurate distance using the plurality of distances and corresponding weighting factors.

According to another embodiment, a method of determining a spatial position of a wireless device is disclosed. The method comprises utilizing a plurality of initiator devices, wherein each initiator device: performs a plurality of round trip time (RTT) procedures with the wireless device, each procedure using one of a plurality of data channels, to generate a plurality of distance measurements; calculates a distance to the wireless device based on the plurality of distance measurements; and calculates a quality indicator based on the distance and the plurality of distance measurements; and using a computational device to receive the distance and quality indicator from the plurality of initiator devices, wherein the computation device uses at least three of the distances and quality indicators to determine the spatial position of the wireless device. In some embodiments, the spatial position of the wireless device is calculated using weights determined from the quality indicators. In some embodiments, the quality indicator calculated by a first initiator device is used to assign a weight to a loci of possible locations associated with the first initiator device. In some embodiments, if the quality indicator for the first initiator device is outside a predetermined range, the weight assigned is set to 0. In some embodiments, a subset of distances received from the plurality of initiator devices, are used to determine the spatial position of the wireless device, wherein the subset is selected based on associated quality indicators, such that only distances deemed to be most accurate are used to determine the spatial position of the wireless device.

According to another embodiment, a method of calculating a distance between two wireless devices and a quality indicator associated with the distance is disclosed. The method comprises performing a plurality of round trip time (RTT) procedures, each using one of a plurality of data channels, to generate a plurality of distance measurements; calculating the distance based on the plurality of distance measurements; and calculating the quality indicator based on a receive signal strength indicator (RSSI) values of the plurality of distance measurements. In some embodiments, the quality indicator is calculated using a standard deviation of a plurality of RSSI values. In some embodiments, the quality indicator is expressed as a value between 0 and 1 and is defined as 1 minus a product of a scaling factor multiplied by the standard deviation of the plurality of RSSI values.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a representative initiator device that may estimate distance according to one embodiment;

FIG. 2 shows a Bluetooth network with an initiator device and a reflector device;

FIG. 3 shows the calculation of round trip time according to the prior art;

FIG. 4A shows a graph showing a plurality of distance measurement results and FIG. 4B shows a histogram showing the distribution of one distance measurement result in an environment without multi-path;

FIG. 5A shows a graph showing a plurality of distance measurement results and FIG. 5B shows a histogram showing the distribution of one distance measurement result in an environment with multi-path;

FIGS. 6-8 show the quality indicator as a function of absolute distance error according to three embodiments; and

FIG. 9 shows a configuration with multiple initiator devices to determine the spatial position of the mobile device.

### DETAILED DESCRIPTION

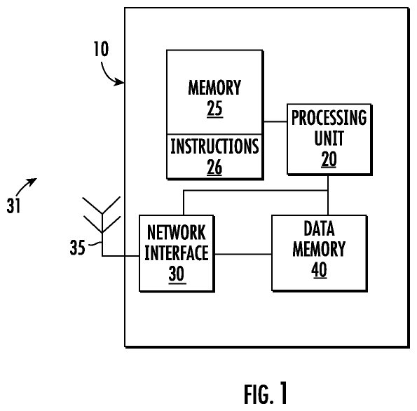

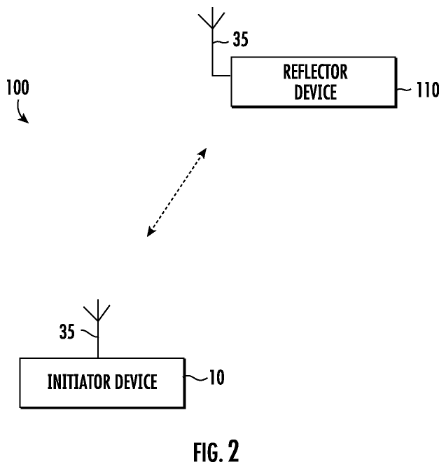

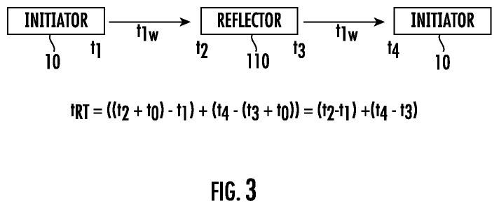

FIG. 1 shows a block diagram of a representative network device. This network device may serve as an initiator device 10, as described in more detail below. This network device may also be used to determine the distance to a remote device, also referred to as a reflector device 110.

The initiator device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the initiator device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

The initiator device 10 also includes a network interface 30, which may be a wireless interface including an antenna element 35. The network interface 30 includes a read circuit and a transmit circuit.

The wireless signals first enter the network interface 30 through antenna element 35. The antenna element 35 is in electrical communication with a low noise amplifier (LNA). The LNA receives a very weak signal from the antenna element 35 and amplifies that signal while maintaining the signal-to-noise ratio (SNR) of the incoming signal. The amplified signal is then passed to a mixer. The mixer is also in communication with a local oscillator, which provides two phases to the mixer. The cosine of the frequency may be referred to as Iₒ, while the sin of the frequency may be referred to as Qₒ. The Iₒ signal is then multiplied by the incoming signal to create the inphase signal, Iₘ. The Qₒ signal is then multiplied by a 90° delayed version of the incoming signal to create the quadrature signal, Qₘ. The inphase signal, Iₘ, and the quadrature signal, Qₘ, from the mixer are then fed into programmable gain amplifier (PGA). The PGA amplifies the Iₘ and Qₘ signals by a programmable amount. These amplified signals may be referred to as I_{g} and Q_{g}. The amplified signals, I_{g} and Q_{g}, are then fed from the PGA into an analog to digital converter (ADC). The ADC converts these analog signals to digital signals, I_{d} and Q_{d}. These digital signals may then pass through a channel filter. The filtered signals are referred to as I and Q. These I and Q signals can be used to recreate the amplitude and phase of the original signal.

Further, the network interface 30 may include circuitry to enable the computation of the received signal strength indicator (RSSI) of an incoming signal. RSSI is typically calculated based on the signal strength of the received signal as measured by the read circuit.

The network interface 30 may support any wireless network, such as Bluetooth, Wi-Fi, networks utilizing the IEEE 802.15.4 specification, such as Zigbee, networks utilizing the IEEE 802.15.6 specification, and wireless smart home protocols, such as Z-Wave. The network interface 30 is used to allow the initiator device to communicate with other devices disposed on the network 31.

The initiator device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the network 31. Although not shown, the initiator device 10 also has a power supply, which may be a battery or a connection to a permanent power source, such as a wall outlet.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions 26 may be written in any programming language and is not limited by this disclosure. Thus, in some embodiments, there may be multiple computer readable media that contain the instructions described herein. The first computer readable media may be in communication with the processing unit 20, as shown in FIG. 1. The second computer readable media may be a CDROM, or a different memory device, which is located remote from the initiator device 10. The instructions contained on this second computer readable media may be downloaded onto the memory device 25 to allow execution of the instructions by the initiator device 10.

While the processing unit 20, the memory device 25, the network interface 30, and the data memory device 40 are shown in FIG. 1 as separate components, it is understood that some or all of these components may be integrated into a single electronic component. Rather, FIG. 1 is used to illustrate the functionality of the initiator device 10, not its physical configuration.

Note that in certain embodiments, the reflector device 110 may also be a network device and contain many of the components described above and shown in FIG. 1. However, the reflector device 110 may have a smaller amount of memory and may have less computational ability.

The previous paragraphs describe the architecture of the initiator device 10 and the procedure to determine the distance using the RTT approach. In certain embodiments, these signals are transmitted using a network protocol, such as Bluetooth.

As noted above, in some environments, the RTT approach may yield different results, based on the frequency of the signal that is used to compute the round trip time. In some experiments, it was found that results across different Bluetooth channels are within a few tens of centimeters when there are no other signal or noise sources present. However, in the presence of noise sources and a multipath environment, the results may vary as much as several meters.

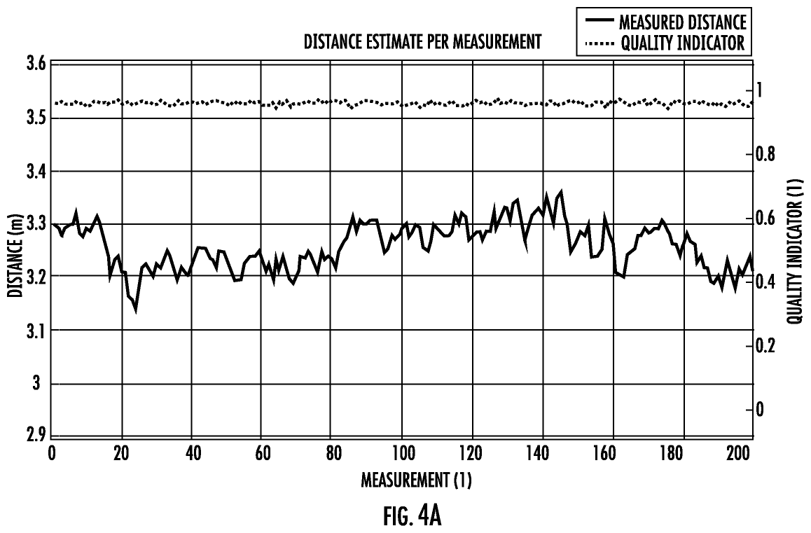

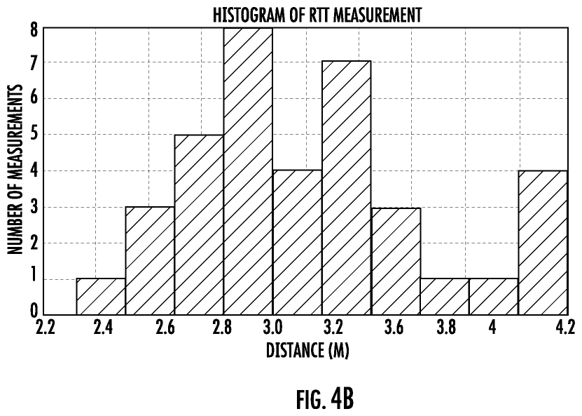

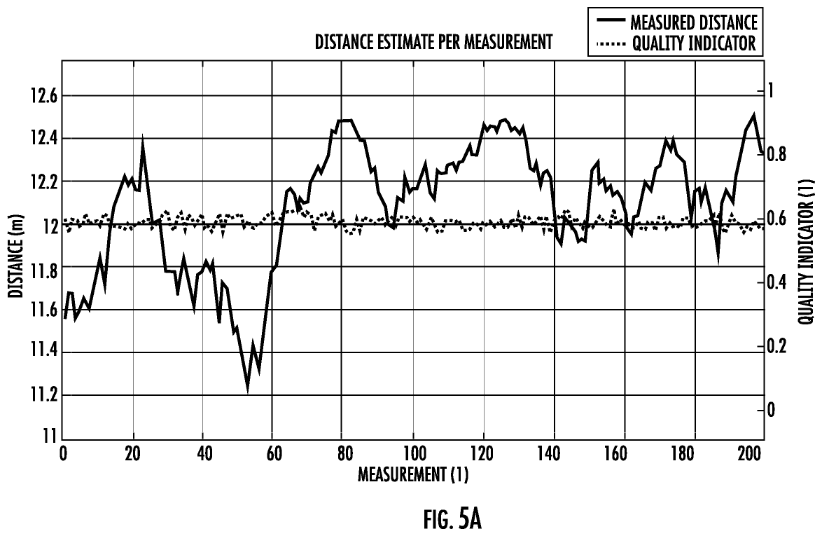

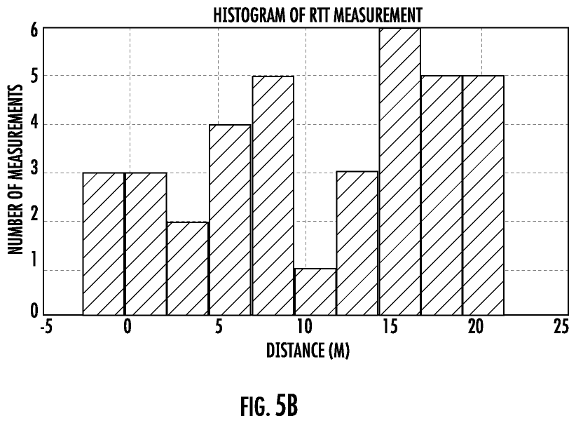

FIGS. 4A-4B and 5A-5B show the results of two different tests that demonstrate these differences. FIGS. 4A-4B illustrate an experiment where there are no noise sources and no multipath environment. In this test, the devices were placed about 3.25 meters away from one another. The RTT approach was used to measure the distance between these devices, using a plurality of different Bluetooth channels. FIG. 4A shows a graph having 200 points. Each of these points was determined by performing the RTT procedure described in FIG. 3 using each of the 37 data channels. The average of these 37 measurements is then displayed as a point on the graph. Note that all of the points are within about 0.2 meters of one another. FIG. 4B is a histogram showing the details associated with one of these points. As noted above, each point is made up of 37 measurements. The histogram shows the actual distance for each of the 37 measurements. As can be seen, the measurements create a graph that is roughly Gaussian in shape. In fact, more than half of the 37 measurements are within 0.2 meters of the average value.

Note that HADM defines more than 37 channels. In some embodiments, more than 70 channels may be available to perform this RTT procedure. In all embodiments described herein, the RTT procedure is performed on a plurality of data channels. However, while FIGS. 4A-4B and 5A-5B use 37 channels, there is no specific number of data channels that must be used.

FIGS. 5A-5B show an experiment in a multipath environment. Again, FIG. 5A is a graph that shows 200 points, wherein each point is determined by performing a distance measurement on each data channel. Note that the computed distances are between 11.3 meters and 12.5 meters; a spread that is five times larger than occurred in the test represented in FIGS. 4A-4B. FIG. 5B is a histogram showing the actual distance measurements for one of these points. Note that the measurements are varied, and lack the Gaussian shape shown in FIG. 4B. In fact, there are as many measurements that are at or below 5 meters as there are measurements that are above 15 meters.

Based on this data, one may assume that the results associated with FIGS. 4A-4B are much more accurate than the results associated with FIGS. 5A-5B. Thus, it would be beneficial if there was a quality indicator associated with the distance measurement. There are several approaches that may be used to compute a quality indicator. In one approach, the quality indicator is expressed as a distance, such as the deviation from the mean. In another approach, the quality indicator is represented as a likelihood or confidence level that may have a range from 0 to 1, or a percentage from 0% to 100%.

In each embodiment, the RTT procedure is performed a plurality of times to generate a plurality of distance measurements. In some embodiments, the RTT procedure is performed on 37 data channels, although a different number of data channels may be used. In one embodiment, the arithmetic average of this plurality of distance measurements may be used as the final distance measurement. In another embodiment, the median value of this plurality of distance measurements may be used as the final distance measurement. In another embodiment, a weighted average may be used. For example, weights may be applied to each measurement based on RSSI or some other measure. In another embodiment, the final distance may be a percentile other than the 50th percentile (which is the median). This may be based on the observation that multipath tends to skew distributions to larger distances. Based on these distance measurements, a quality indicator is also calculated for this data point.

There are several different approaches that may be used to create a quality indicator that is a distance. This value may also be referred to as a distance deviation. In one embodiment, the quality indicator may be related to the standard deviation of these plurality of distance measurements. In some embodiments, the quality indicator may be the standard deviation. In other embodiments, the quality indicator may be derived from the standard deviation.

In another embodiment, the quality indicator may be related to the difference between the largest distance measurement and the smallest distance measurement. In some embodiments, the quality indicator is equal to this difference. In other embodiments, the quality indicator may be based on this difference, such as half of this difference.

In a third embodiment, the quality indicator may be related to the largest difference between the final distance measurement and any of the plurality of distance measurements.

In a fourth embodiment, the quality indicator may be related to the difference between the average and median distance measurements.

The operations that are performed to obtain each of these different distance deviations are well known to those skilled in the art.

In other embodiments, the quality indicator may be expressed as a value between 0 and 1, wherein 1 represents high likelihood or confidence in the final distance measurement and 0 represents no confidence in the final distance measurement.

In certain embodiments, the quality indicator is created by subtracting the distance deviation, multiplied by a scaling factor, from one. In other words, in some embodiments,

$$QI = 1 - a * ( distance deviation )$$

where QI is the quality indicator, and a is a scaling factor that is between 0 and 1. The value of a may be determined empirically. If the resulting quality indicator becomes negative, it is changed to 0. Thus, in this embodiment, the quality indicator is linearly related to the distance deviation, as computed above.

Note that any of the distance deviations described above may be used to create this quality indicator.

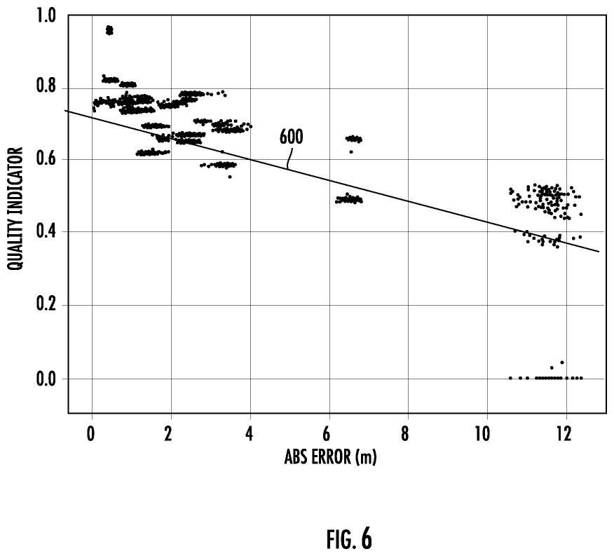

FIGS. 6-8 show the quality indicator as a function of absolute error. The horizontal axis in these graphs represents the absolute value of the difference between the actual distance and the measured distance, which is defined as absolute distance error. The vertical axis represents the quality indicator associated with that absolute distance error.

FIG. 6 utilizes the standard deviation of the distance measurements as the distance deviation that is used to calculate the quality indicator. The trend line 600 shows that the quality indicator decreases roughly linearly as the absolute distance error increases. Note that by changing the scaling factor (a), the slope of this graph may be adjusted.

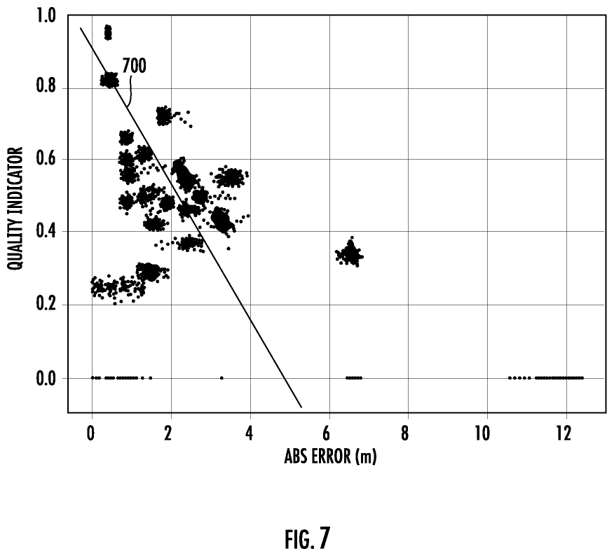

FIG. 7 utilizes the difference between the largest distance measurement and the smallest distance measurement as the distance deviation that is used to calculate the quality indicator. Again, trend line 700 shows that the quality indicator decreases roughly linearly as the absolute distance error increases. Note that by changing the scaling factor (a), the slope of this graph may be adjusted. Note that the points on the graph shown in FIG. 7 are more scattered than those in FIG. 6. This may be because one outlier has a much greater effect on the quality indicator used in FIG. 7 than on the quality indicator used in FIG. 6.

In another embodiment, the quality indicator may be created based on the ratio of the distance deviation to the final distance measurement. This may be expressed as:

$$QI = 1 - a * \frac{( distance deviation )}{( final distance measurement )}$$

Note that in the first mathematical expression, the quality indicator is only affected by the distance deviation. Thus, a first measurement with a final distance measurement of 2 meters with a distance deviation of 1 meter will have the same quality indicator as a second measurement with a final distance measurement of 50 meters with the same distance deviation. The second mathematical expression for quality indicator allows a higher quality indicator to be computed for this second measurement, because, as a percentage, the distance deviation is much smaller.

Further, the quality indicator may be created using other parameters. For example, in one embodiment, the initiator device 10 may calculate the received signal strength indicator (RSSI) of each received packet. The standard deviation of all of these RSSI values may be computed and used to calculate the quality indicator. In other words,

$$QI = 1 - a * ( std\_deviation ( RSSI ) )$$

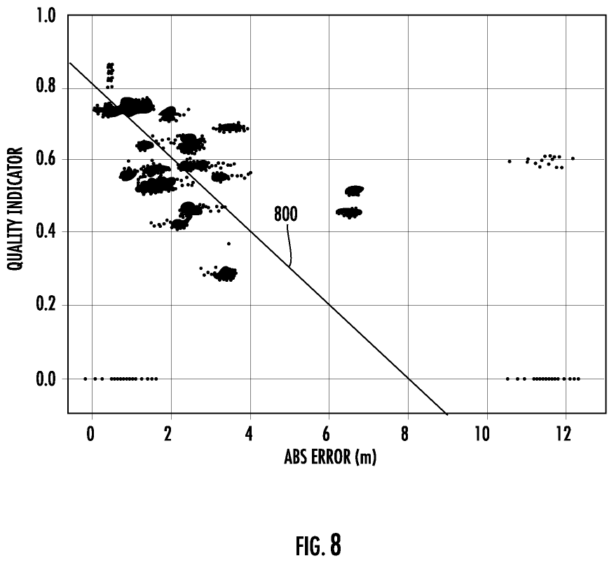

In an environment with no noise sources and no multi-path, many of the received packets should have the same or very similar signal strengths. Thus, variations in RSSI may be indicative of multi-path or noise. FIG. 8 shows a graph that plots quality indicator, calculated using RSSI, as a function of absolute distance error. Note that the trend line 800 shows that the quality indicator decreases roughly linearly as the absolute distance error increases. Note that by changing the scaling factor (a), the slope of this graph may be adjusted.

The quality indicator metric may be used in various ways. In one embodiment, the quality indicator may be used to filter out bad/low quality measurements and/or to let the end user know the quality/reliability of the measurement. In response, the user may choose to ignore the measurement. In another embodiment, the initiator device 10 may obtain a plurality of distance measurements, using the RTT procedure described above, each distance measurement having a respective quality indicator. These distance measurements may then be post-processed to obtain a more accurate distance measurement. For example, the initiator device 10 may perform a plurality of distance measurements. These distance measurements may then each be multiplied by a respective weight, which is derived from the respective quality indicator. These products may then be added together and divided by the sum of the weights to obtain the more accurate distance measurement. In certain embodiments, the quality indicators are calculated as a value between 0 and 1 and also serve as the weights. Specifically, the more accurate distance measurement may be defined as:

$$\frac{\sum ( {w}_{i} * {D}_{i} )}{\sum {w}_{i}}$$

where wᵢ is the weight assigned to the distance measurement (Dᵢ) from initiator device i; and Σwᵢ is the sum of all of the weights.

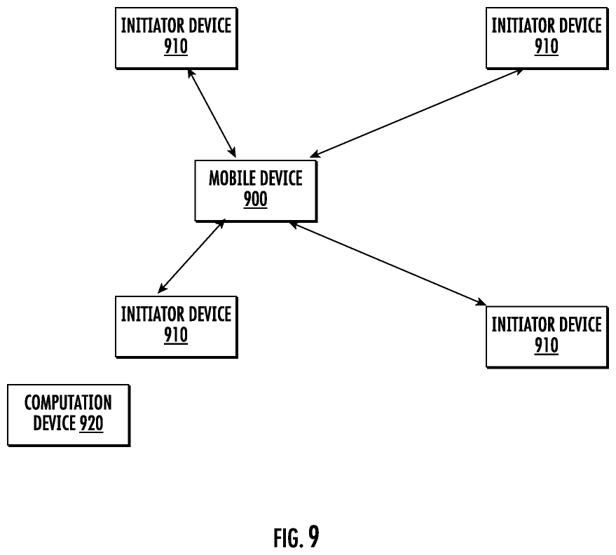

In another embodiment, shown in FIG. 9, a plurality of initiator devices 910 may be in communication with one mobile device 900. Each initiator device 910 is at a known location and generates distance measurements and quality indicators relative to that mobile device 900. A centralized computational device 920 may then receive the distance measurement from each initiator device 910 as well as its quality indicator and use a three-dimensional position algorithm, such as trilateration, to determine the location of the mobile device 900.

In one embodiment, the quality indicator may be treated using a binary filter, where quality indicators are deemed to be either acceptable or unacceptable. Thus, in these embodiments, the centralized computational device 920 may disregard distance measurements from any initiator device 910 which reported a quality indicator outside a predetermined range. For example, distances that have a quality indicator below a certain value may be disregarded. Thus, in this embodiment, the centralized computational device 920 may use a subset of the distances, less than the plurality of distances to determine the location of the mobile device 900.

However, other embodiments are also possible. For example, in another embodiment, the quality indicator reported by the various initiator devices 910 are sorted according to accuracy. In this embodiment, only the N most accurate results are used to calculate the spatial position, where N is a value of 3 or more. In another embodiment, the top N percentile of quality indicators are used.

In both of these scenarios, the centralized computational device 920 utilizes a selected number of distance measurements that are believed to be the most accurate. The information from the most accurate initiator devices 910 may then be used as follows. The distance measurement from each initiator device is used to determine the loci of possible locations of the mobile device 900, using simple trigonometry. For example, the loci of potential locations for the mobile device 900 may be located along a circle or sphere having a radius equal to the distance measurement reported by that initiator device 910. After all of the loci are calculated based on the distance measurement from each initiator device 910, this information may be used to determine the actual position of the mobile device 900.

In another embodiment, the quality indicator may be treated along a continuum, where the value of the quality indicator is indicative of its perceived confidence level. In this embodiment, the centralized computational device 920 may calculate the loci of possible locations of the mobile device 900 for each initiator device 910, as described above. However, in this embodiment, each loci is assigned a weight based on the quality indicator of the distance measurements that were used to generate that loci, wherein higher weights indicate a more accurate result. Then, the location of the tracked device may be computed as the weighted average of all of the loci. As an example, the actual position of the mobile device 900 may be computed by calculating the minimum value for the following expression:

$${\sum }_{i} ( {w}_{i} * {( {D}_{i} - {d}_{i} )}^{2} )$$

where wᵢ is the weight for the distance measurement for initiator device i;
Dᵢ is the actual distance from the mobile device 900 to the initiator device i; and
di is the distance measurement calculated by initiator device i.

In yet another embodiment, a combination of these approaches may be used, wherein a binary filter is used to eliminate results believed to be inaccurate and the remaining results are weighted according to their perceived accuracy.

The present system has many advantages. As shown in FIGS. 5A-5B, in a multi-path environment, distance measurements made using the RTT procedure may not be accurate due to reflections or other phenomenon. However, by observing all of the distance measurements that were performed by the RTT procedure, it is possible to develop a quality indicator or level of confidence for the distance measurement. This quality indicator may then be used to determine whether and how this distance measurement may be used in future calculations. These future calculations may be associated with determining a more accurate distance measurement or determining a spatial position of a device. Further, the methods used to create this quality indicator show good correlation to the actual accuracy of the distance measurements.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of calculating a distance between two wireless devices and a quality indicator associated with the distance, comprising:
performing a plurality of round trip time (RTT) procedures, each using one of a plurality of data channels, to generate a plurality of distance measurements;
calculating the distance based on the plurality of distance measurements; and
calculating the quality indicator based on the distance and the plurality of distance measurements.

2. The method of claim 1, wherein the distance is calculated as an average of the plurality of distance measurements.

3. The method of claim 1, wherein the distance is calculated as a median of the plurality of distance measurements.

4. The method of claim 1, wherein the quality indicator is expressed as a distance deviation.

5. The method of claim 4, wherein the quality indicator is calculated using a standard deviation of the plurality of distance measurements.

6. The method of claim 4, wherein the quality indicator is calculated using a difference between a largest of the plurality of distance measurements and a smallest of the plurality of distance measurements.

7. The method of claim 4, wherein the quality indicator is calculated using a largest difference between one of the plurality of distance measurements and the distance.

8. The method of claim 1, wherein the quality indicator is expressed as a value between 0 and 1 and is defined as 1 minus a product of a scaling factor multiplied by a distance deviation.

9. The method of claim 8, wherein the distance deviation is defined as a standard deviation of the plurality of distance measurements.

10. The method of claim 8, wherein the distance deviation is defined as a difference between a largest of the plurality of distance measurements and a smallest of the plurality of distance measurements.

11. The method of claim 8, wherein the distance deviation is defined as a largest difference between one of the plurality of distance measurements and the distance.

12. A method of determining a more accurate distance between two wireless devices, comprising:
performing the method of claim 1 a plurality of times to obtain a plurality of distances and associated quality indicators;
creating a weight factor corresponding to each of the plurality of distances based on the associated quality indicator; and
calculating the more accurate distance using the plurality of distances and corresponding weighting factors.

13. A method of determining a spatial position of a wireless device, comprising:
utilizing a plurality of initiator devices, wherein each initiator device:
performs a plurality of round trip time (RTT) procedures with the wireless device, each procedure using one of a plurality of data channels, to generate a plurality of distance measurements;
calculates a distance to the wireless device based on the plurality of distance measurements; and
calculates a quality indicator based on the distance and the plurality of distance measurements; and
using a computational device to receive the distance and quality indicator from the plurality of initiator devices, wherein the computation device uses at least three of the distance and quality indicators to determine the spatial position of the wireless device.

14. The method of claim 13, wherein the spatial position of the wireless device is calculated using weights determined from the quality indicators.

15. The method of claim 14, wherein the quality indicator calculated by a first initiator device is used to assign a weight to a loci of possible locations associated with the first initiator device.

16. The method of claim 15, wherein, if the quality indicator for the first initiator device is outside a predetermined range, the weight assigned is set to 0.

17. The method of claim 13, wherein a subset of distances received from the plurality of initiator devices, are used to determine the spatial position of the wireless device, wherein the subset is selected based on associated quality indicators, such that only distances deemed to be most accurate are used to determine the spatial position of the wireless device.

18. A method of calculating a distance between two wireless devices and a quality indicator associated with the distance, comprising:
performing a plurality of round trip time (RTT) procedures, each using one of a plurality of data channels, to generate a plurality of distance measurements;
calculating the distance based on the plurality of distance measurements; and
calculating the quality indicator based on a receive signal strength indicator (RSSI) values of the plurality of distance measurements.

19. The method of claim 18, wherein the quality indicator is calculated using a standard deviation of a plurality of RSSI values.

20. The method of claim 19, wherein the quality indicator is expressed as a value between 0 and 1 and is defined as 1 minus a product of a scaling factor multiplied by the standard deviation of the plurality of RSSI values.
